(19) United States
(12) Patent Application Publication
(10) Pub. No.: US 2002/0112587 A1
(43) Pub. Date: Aug. 22, 2002

(54) Power knife

(76) Inventor: Douglas D. DeWitt, Bakersfield, CA (US)

Correspondence Address: James M Duncan, Klein DeNatale Goldner Cooper Rosenlieb & Kimball, P O Box 11172, Bakersfield, CA, 93389-1172, US

(21) Appl. No.: 09/790,227

(22) Filed: Feb. 21, 2001

(51) Int. Cl. B26D 7/26

(52) U.S. Cl. 83/574; 83/589; 83/698.11; 83/698.31

(57) ABSTRACT

A knife and cutting board combination, in which the knife blade is attached to a swing assembly, where the swing assembly has vertical supports and swing arms. Attaching the blade to the swing assembly allows the entire knife to be elevated above the cutting board and further allows the knife blade to move both vertically and longitudinally with respect to the cutting board. The vertical supports may be attached to the cutting board or the vertical supports may be part of a rotating base. A spring sleeve assembly is disclosed which allows any common kitchen knife to be attached to the swing assembly.

### BACKGROUND OF THE INVENTION

The present invention is generally directed to knives used for food preparation such as cutting, slicing or chopping, and more specifically to a knife and cutting board combination which increases the ease and accuracy of such operations, particularly for the elderly and those suffering from various physical disabilities.

It is known that attaching the tip of a knife blade to a cutting board, so that the blade pivots at the point of attachment, assists the user in cutting operations. Attaching the knife to the cutting board allows the user to apply increased pressure to the knife handle without the blade slipping. Attaching the knife blade to the cutting board also makes cutting operations easier for those who may have a limited range of motion in their hands, wrists or arms because of arthritis or other disability.

U.S. Pat. No. 4,054,994 discloses a knife and fixture for attaching a knife to a bread board, where the front of the knife is pivoted to an attachment which is slipped on the edge of the bread board. In one embodiment, the knife is provided with a longitudinally extending slot at the forward end so that the knife may be guided and moved longitudinally. U.S. Pat. No. 4,247,984 discloses a knife and chopper board combination in which the knife pivots on a horizontal pivot pin mounted to the chopper board. In these knife and cutting board combinations, the pivot point for the knife is the front end of the blade, thereby preventing the front end of the knife from being lifted off of the cutting board. Each of these devices is designed to be operated with a downward motion, as opposed to a longitudinal motion or a combination of downward and longitudinal motion. The latter type of motion often provides a superior cut for many food items, such as bread, fruit and vegetables. Although U.S. Pat. No. 4,054,994 discloses an alternative embodiment which allows longitudinal motion, the amount of motion is limited by the length of the slot, and slicing operations can be made more difficult from friction between the slot and the horizontal pivot.

The above devices require a specially manufactured knife to attach to the pivoting mechanism. The knife blade disclosed in U.S. Pat. No. 4,054,994 has either a hole or a slot for attaching the blade to a horizontal pivot. The knife blade disclosed in U.S. Pat. No. 4,247,984 has a slot machined in the forward end of the blade. It would be advantageous to have a knife-cutting board combination in which any common kitchen knife could be attached to the cutting board, rather than a knife specifically machined for attachment to the cutting board. A knife-cutting board combination which utilizes common kitchen knives would be less expensive to manufacture and would allow different types of knives to the cutting board so that the particular knife attached to the cutting board is the optimal knife for the particular food item being cut or sliced.

### SUMMARY OF THE INVENTION

The present invention is directed to a knife-cutting board combination which meets the need identified above. The disclosed apparatus is comprised of three major components, a knife, a cutting board, and a swing assembly. The swing assembly is comprised of a pair of vertical supports which are mounted to the cutting board at the bottom end of each support, each support facing the other. Swing arms, each having a support end and a free end, are pivotly attached at the support ends to the top end of the vertical supports, so that a swing arm is attached to each vertical support. The swing arms are disposed so that the free ends swing freely between the pair of vertical supports. The free ends of the swing arms are biased towards each other, and are pivotly attached to the blade of the knife so that the blade is free to swing between the pair of supports. One means of attaching the knife blade to the swing arms is utilizing a blade having a hole, where the hole is used for inserting a nut and bolt through the blade and free ends of the swing arms. The knife blade may be raised or lowered with reference to the cutting board according to the length of the swing arms and the height of the supports. The knife blade is free to move forward and backwards on the swing arms, allowing a longitudinal slicing or sawing motion with the blade.

The invention may be constructed so that the swing assembly pivots on the cutting board. The free ends of the swing arms may also be pivotly connected to a spring sleeve assembly, having an outer sleeve and an inner sleeve, where the inner sleeve is adapted to receive and retain the blade of a common kitchen knife.

These and other features, aspects, and advantages of the present invention will become better understood with regard to the following description, appended claims, and accompanying drawings.

### BRIEF DESCRIPTION OF THE DRAWINGS

FIG. 1 is a perspective view of the disclosed invention.

FIG. 2 is a front elevational view of the invention.

FIG. 3 is a side elevational view of the invention.

FIG. 4 is a perspective view of an alternative embodiment of the disclosed invention.

FIG. 5 is a top view of an alternative embodiment of the disclosed invention.

FIG. 6 is a side elevational of an alternative embodiment.

FIG. 7 is a detailed front view of the spring sleeve assembly of the alternative embodiment.

FIG. 8 is a detailed side view of the spring sleeve assembly.

FIG. 9 is a detailed perspective view of the spring assembly.

### DETAILED DESCRIPTION OF THE EMBODIMENTS

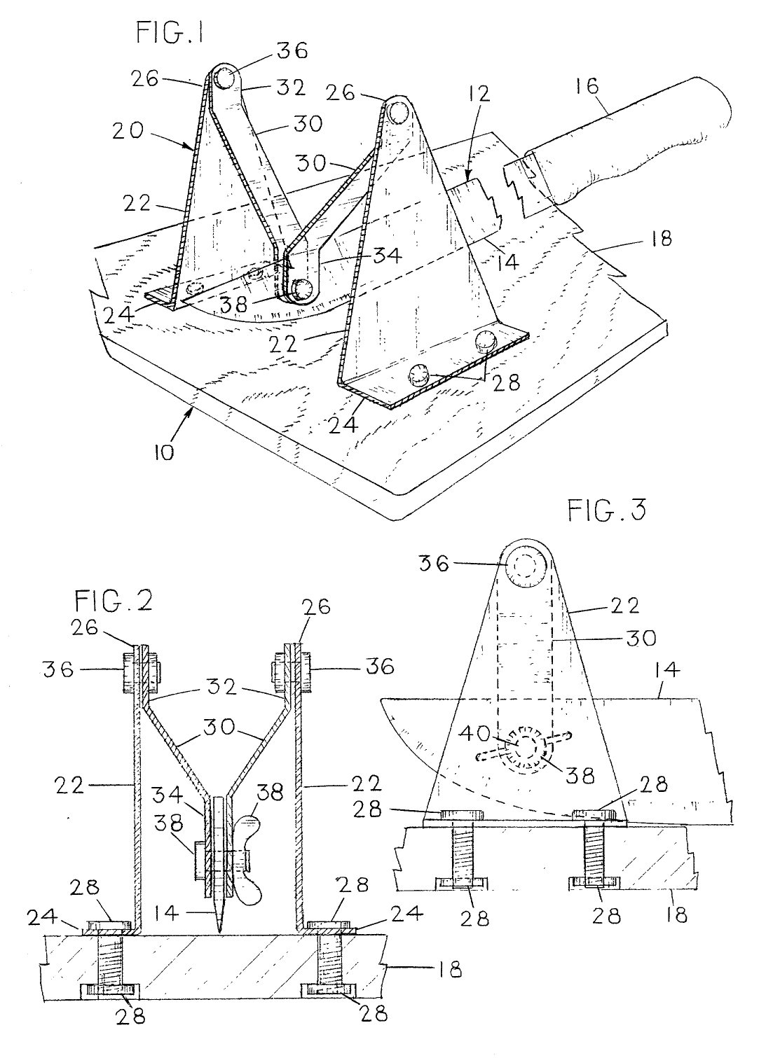

As shown in FIG. 1, the major components of the knife-cutting board combination 10 are a knife 12 having a blade 14 and handle 16, the cutting board 18, and the swing assembly 20. As shown in FIGS. 1 and 2, the swing assembly 20 includes two vertical support pieces 22, which may be triangular in shape, each support piece having a bottom end 24 and a top end 26. The bottom end 24 of each support piece 22 is mounted to the cutting board 18 with fastening means 28, such as nuts and bolts or rivets. As shown in FIG. 2, the bottom side of the cutting board 18 may be counter-sunk so that nuts or rivet heads are recessed into the bottom of the cutting board.

As shown in FIGS. 2 and 3, a swing arm 30 is attached to the top end 26 of each support piece 22. Each swing arm 30 has a support end 32 and a free end 34. The support end 32 of each swing arm 30 is attached to the top end 26 of a vertical support piece 22 by a first attachment means 36, such as a locknut and bolt combination or rivet, which are so installed so as to allow the swing arm 30 to pivot freely on the support piece 22.

As shown in FIG. 2, the vertical support pieces 22 are mounted to the cutting board 18 so that the support pieces are parallel to one another, with sufficient distance between the two support pieces for the two swing arms 30 and the knife blade 14 to swing freely. As further shown in FIG. 2, the free end 34 of each swing arm 30 is connected to the knife blade 14 with a second attachment means 38, such as a wingnut and bolt combination, or rivet, which are installed through a hole 40 in the knife blade. The second attachment means 38 is so installed as to allow the knife blade 14 to pivot vertically between the swing arms 30. If a wingnut and bolt combination is used as the second attachment means 38, the knife 12 may be easily removed from the swing assembly 20 for cleaning or replacement simply by removing the wingnut. In this manner, a variety of different knives, having a hole 40 in the blade 14, may be used with the device.

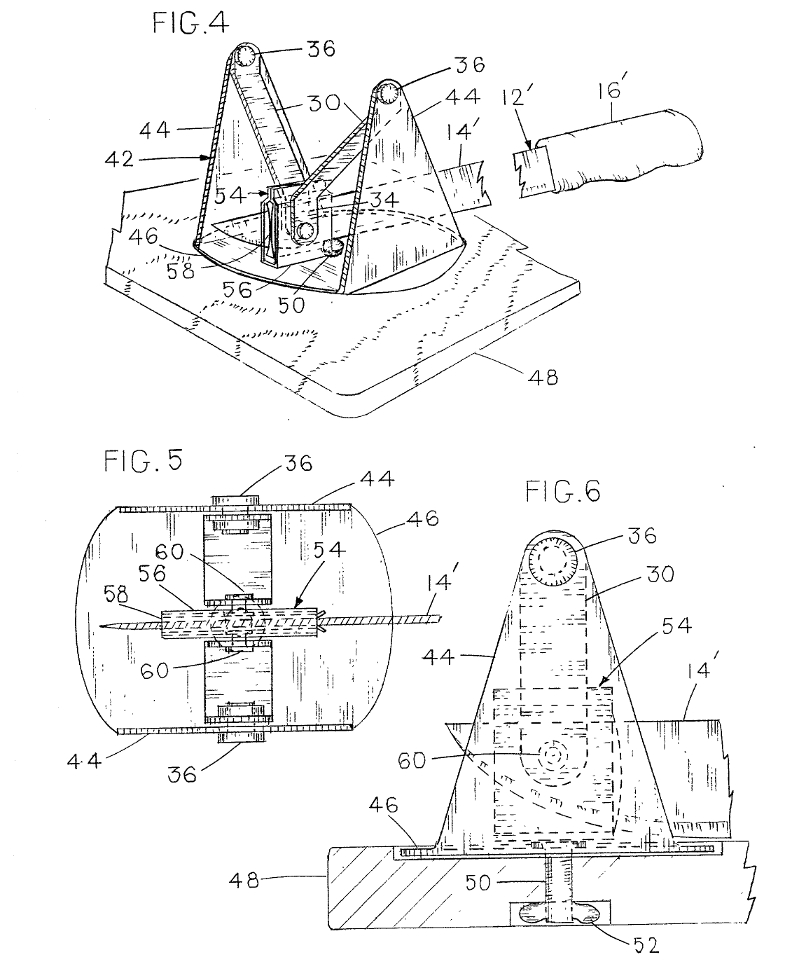

An alternative embodiment of the invention is disclosed in FIGS. 4 and 6 which disclose a pivoting swing assembly 42. In this embodiment, the support pieces 44 are fabricated from a single piece of material, which material also forms the base 46 of the pivoting swing assembly 42. The base 46 and contoured cutting board 48 are configured so that a spindle 50 may be attached to the contoured cutting board so as to allow the pivoting swing assembly 42 to rotate on the cutting board. One means of attaching the spindle 50 is drilling matching holes through the contoured cutting board 48 and the base 46. As shown in FIG. 6, the spindle 50 may be threaded so as to attach the spindle to the contoured cutting board 48 with a retaining nut 52. As shown in FIG. 6, the top of the contoured cutting board 48 is scalloped so that the base 46 of the pivoting swing assembly 42 is flush with the top of the contoured cutting board 48 and the pivoting swing assembly 42 pivots freely on the spindle 50.

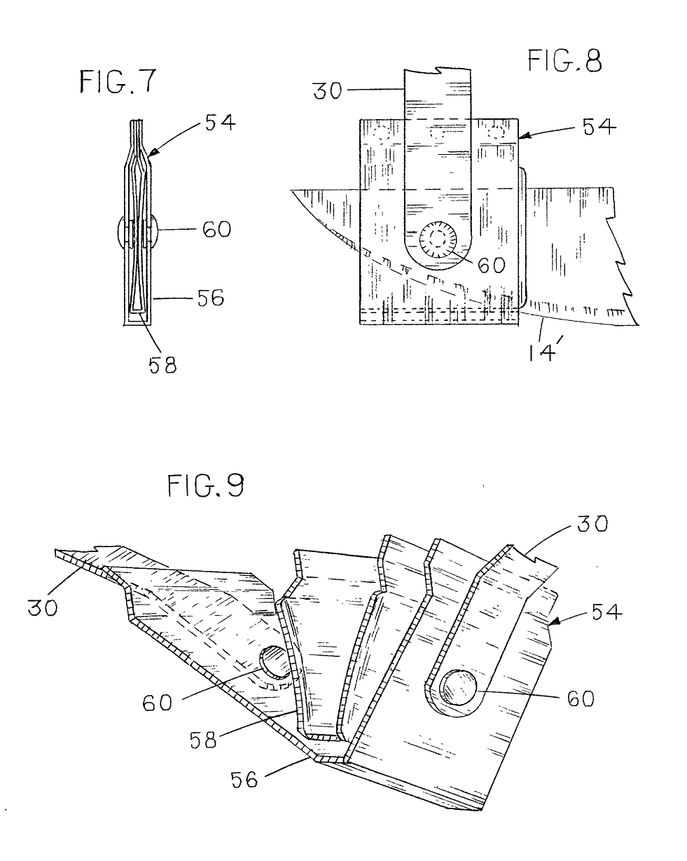

An alternative means of attaching a knife 12′ is disclosed in FIGS. 4 through 8. This embodiment includes a spring sleeve assembly 54 which is adapted to receive and retain any common kitchen knife 12′ for use with the invention. The spring sleeve assembly 54 is adaptable to either the swing assembly 20 of the first embodiment or the pivoting swing assembly 42 of the alternative embodiment. The spring sleeve assembly 54 is made up of two components, an outer sleeve 56 and an inner sleeve 58. As shown in FIG. 4, the two swing arms 30 are attached to either side of the spring sleeve assembly 54, with the free end 34 connected to the outer sleeve 56 with a fastening device 60, such as a bolt or rivet, so as to allow the spring sleeve assembly 54 to pivot between the swing arms 30. The inner sleeve 58 is spot welded to the outer sleeve 56 so that the inner sleeve is retained within the outer sleeve. The inner sleeve 58, which provides a friction fit for the knife blade 14′, may be constructed of spring steel to provide a positive grip on the blade. As shown in FIG. 5, the inner sleeve 58 may be flared on the leading edge so as to make it easier to install the knife blade 14′ in the spring sleeve assembly 54.

Use of the disclosed apparatus is simple. The user simply lifts the knife handle 16 to cause the point of the blade 14 to rotate up towards the user. A food item is then placed on the cutting board 18 under the blade 14. The user pushes down and forward on the handle 16, causing the tip of the blade 14 to rotate back down to the cutting board 18.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A knife-cutting board combination, comprising:
(a) a knife, having a blade and a handle;
(b) a cutting board;
(c) a pair of vertical supports disposed in spaced apart facing relation, each support having a bottom end fixed to the cutting board and each support having a top end;
(d) a pair of swing arms, disposed between the pair of vertical supports, each swing arm having a support end and a free end, each support end pivotly attached to the top end of a vertical support with a first attachment means; and
(e) a second attachment means pivotly attaching the free end of each swing arm to the blade, such that the free ends are biased towards each other in facing relation, and the blade is free to swing between the pair of supports.

2. The knife-cutting board combination of claim 1, wherein the first attachment means comprises a bolt with matching nut.

3. The knife-cutting board combination of claim 1, wherein the first attachment means comprises a rivet.

4. The knife-cutting board combination of claim 1, further comprising the blade having a hole.

5. The knife-cutting board combination of claim 4, wherein the second attachment means comprises a bolt and wing nut.

6. A knife-cutting board combination, comprising:
(a) a knife, having a blade and a handle;
(b) a cutting board;
(c) a support assembly comprising a pair of vertical supports fastened to a horizontal base plate, each support having a top end, the base plate pivotly attached to the cutting board with fastening means;
(d) a pair of swing arms, disposed between the pair of vertical supports, each swing arm having a support end and a free end, each support end pivotly attached to the top end of a separate support with a first attachment means; and
(e) a second attachment means pivotly attaching the free end of each swing arm to the blade, such that the free ends are biased towards each other in facing relation, and the blade is free to swing between the pair of supports.

7. The knife-cutting board combination of claim 6, wherein the fastening means comprises a spindle connected to the cutting board.

8. The knife-cutting board combination of claim 6, wherein the first attachment means comprises a bolt with matching nut.

9. The knife-cutting board combination of claim 6, wherein the first attachment means comprises a rivet.

10. The knife-cutting board combination of claim 6, wherein the cutting board is contoured.

11. The knife-cutting board combination of claim 6, further comprising the blade having a hole.

12. The knife-cutting board combination of claim 11, wherein the second attachment means comprises a bolt and wing nut.

13. A knife-cutting board combination, comprising:
(a) a knife, having a blade and a handle;
(b) a cutting board;
(c) a pair of vertical supports disposed in spaced apart facing relation, each support having a bottom end fixed to the cutting board and each support having a top end;
(d) a pair of swing arms, disposed between the pair of vertical supports, each swing arm having a support end and a free end, each support end pivotly attached to the top end of a separate support with a first attachment means; and
(e) a spring sleeve assembly comprised of an inner sleeve and an outer sleeve, the inner sleeve disposed inside the outer sleeve, the inner sleeve adapted to retain the blade, the outer sleeve pivotly attached to the free end of each swing arm such that the free ends are biased towards each other in facing relation, and the spring sleeve assembly is free to swing between the pair of vertical supports.

14. The knife-cutting board combination of claim 13, wherein the first attachment means comprises a bolt with matching nut.

15. The knife-cutting board combination of claim 13, wherein the first attachment means comprises a rivet.

16. A knife-cutting board combination, comprising:
(a) a knife, having a blade and a handle;
(b) a cutting board;
(c) a support assembly comprising a pair of vertical supports fastened to a horizontal base plate, each support having a top end, the base plate pivotly attached to the cutting board with fastening means;
(d) a pair of swing arms, disposed between the pair of vertical supports, each swing arm having a support end and a free end, each support end pivotly attached to the top end of a vertical support with a first attachment means; and
(e) a spring sleeve assembly comprised of an inner sleeve and an outer sleeve, the inner sleeve disposed inside the outer sleeve, the inner sleeve adapted to retain the blade, the outer sleeve pivotly attached to the free end of each swing arm such that the free ends are biased towards each other in facing relation, and the spring sleeve assembly is free to swing between the pair of supports.

17. The knife-cutting board combination of claim 16, wherein the fastening means comprises a spindle connected to the cutting board.

18. The knife-cutting board combination of claim 16, wherein the first attachment means comprises a bolt with matching nut.

19. The knife-cutting board combination of claim 16, wherein the first attachment means comprises a rivet.

20. The knife-cutting board combination of claim 16, wherein the cutting board is contoured.
